(19) United States
(12) Patent Application Publication
(10) Pub. No.: US 2010/0143661 A1
(43) Pub. Date: Jun. 10, 2010

(54) Energy Absorption Material

(76) Inventor: Russell C. Warrick, Seattle, WA (US)

Correspondence Address: CHARLES J RUPNICK, PO BOX 46752, SEATTLE, WA, 98146, US

(21) Appl. No.: 12/590,999

(22) Filed: Nov. 17, 2009

Related U.S. Application Data
(60) Provisional application No. 61/199,561, filed on Nov. 18, 2008.

(51) Int. Cl. B32B 27/34; B32B 1/00; B32B 27/38; B32B 3/26; B32B 37/00

(52) U.S. Cl. 428/174; 428/474.4; 428/413; 428/304.4; 156/60; 977/742

(57) ABSTRACT

An energy absorption material, formed of a plurality of structural layers each formed of a substantially rigid material; a plurality of cushion layers interleaved with the structural layers, with each cushion layer formed of a substantially compressible material; wherein the cushion layers are coupled to adjacent structural layers; and one of the cushion layers and the structural layers is further positioned on a threat face of the energy absorption material.

### FIELD OF THE INVENTION

The present invention relates generally to energy absorption material, and in particular to interleaved materials for pedestrian impact energy absorption for pedestrian protection, wherein hoods and fenders, as well as other vehicle components, are at least partially formed of the energy absorption material.

### BACKGROUND OF THE INVENTION

Energy absorption materials are generally well-known. However, known energy absorption materials do not provide effective and economic pedestrian impact energy absorption for car hoods and fenders and other vehicle components, as well as other applications which are detailed herein.

Effective impact energy management is necessary for limiting peak acceleration and impact force duration in the human brain and body. Acceleration forces due to an impact along with the duration of the impact are used to calculate Head Impact Criterion (HIC) values which indicate the amount of energy and thus, damage, imparted to the brain. HIC values are specified as maximum-allowable values for pedestrian impact testing and certification on new vehicles. With respect to blast shockwaves and ballistic projectiles, energy absorption, energy conversion, and energy attenuation are very important for mitigating human brain injury and body injury.

Known pedestrian protection systems typically either employ an active hood system which deploys the hood upwards to offer a larger deformation zone for impact energy management, inflate airbags to cushion the impact, utilize a single-layer of compressible, non-interleaved material, or utilize cushions to protect pedestrians from under-hood hard points. To meet current and future pedestrian protection requirements, other systems may require higher hoods, smaller and lower engines, or significant repackaging of under-hood components. Unfortunately, higher hoods typically adversely affect the aerodynamics of the vehicle and also detract from certain design aesthetics such as a low hood, which is typically regarded as a desirable design feature for many vehicles including sedans, coupes, and sports-oriented vehicles.

One drawback of known active systems is that they are typically very expensive and heavy and require substantial development time and engineering effort. Single-layer non-interleaved compressible materials typically have a higher peak-load, due to the failure of the material skin on one or both sides of the single-layer of compressible material, followed by compression of the compressible material. These systems often require thicker, stiffer, load-bearing skins, and either do not substantially utilize the compressible material to contribute to mechanical properties of the hood or other component, or the systems have to compensate for their inherent lack of flexural stiffness by utilizing stiffer skins to provide structure to the hood or other component.

Regarding other applications for impact and blast energy management, known systems utilize single-layer, non-interleaved compressible material. Also, transverse compression of the material often requires greater impact energy to initiate material failure or compression of the skin material, followed by a region of lower resistance to compression during the compression of the compressible material. This results in higher peak loads in known systems when the skin fails, followed by a less-efficient conversion of impact energy when the compressible material begins to convert impact energy.

### SUMMARY OF THE INVENTION

The present invention is an energy absorption material and associated configurations, processes and applications useful for, though not limited to pedestrian impact energy absorption for vehicle hoods and fenders and other components, as well as other applications detailed herein.

The novel energy absorption material disclosed herein achieves excellent impact energy management capability due to sequential compression, buckling, and even failure of interleaved layers of the constituent materials. The constituent materials include, for example, a thermoplastic nylon foam from Zotefoams, Zotek-N B50, along with a thermoset epoxy resin prepregged onto woven fiberglass, made by Cytec Engineered Materials of Anaheim, Calif., USA. With this combination of materials, the foam compresses and cushions impacts while the fiberglass and epoxy material buckles and fails while spreading the impact load over a larger area to more effectively cushion an impact and convert impact energy into other forms of energy. Interleaving of materials causes the structural fiberglass and epoxy material to hold the compressible foam in shape after molding. The structural interleaved layers resists flexing and bending of the material substantially because shear loads in the foam are transferred to the structural fiberglass and epoxy layers adjacent to the foam layers.

The material effectively cushions impacts by storing or converting impact energy through controlled compression, deformation, and failure of the constituent materials. The material compresses and fails in a controlled manner and converts impact energy into other forms of energy through a predictable, sequential buckling, deformation, and compression of the constituent materials.

Utilized this novel material for a vehicle hood is analogous to making the hood out of bike-helmet-like material. Material thickness is easily varied by adding additional interleaved layers of material in desired locations to conform to under-hood components. Any dead space between the hood skin and engine bay hard points can be filled with this material to cushion impacts to the underlying structures. The material doesn't need to deform as most prior art metal pedestrian protection hoods which bend over a large area and convert impact energy through deforming the metal. Rather, the novel material disclosed herein fails locally, transverse to the plane of the interleaved material. The thicker the material is, the more cushioning and energy conversion and energy storage capability the material has.

Filling the space between under hood hard points and the vehicle exterior with the novel material disclosed herein is one option for improving the pedestrian protection performance in these areas. Filling the space between under hood hard points and the vehicle exterior with the novel material disclosed herein also helps prevent large scale bending of the hood material as occurs with prior art materials. a Such large scale bending as occurs with prior art materials is a less effective energy conversion mechanism than locally compressing and failing the material with the desired transverse compression energy conversion mechanisms of the novel interleaved materials disclosed herein. The interleaved nature of this novel material also helps resist sharp objects from poking or cutting through the material as easily as in a single-layer materials as are known in the prior art because the interleaved layers of the disclosed material help reinforce the material.

The novel material disclosed herein eliminates the need in the prior art for space-intensive active hood systems and by minimizes the space required for deformation of the hood through the use of a very space-efficient energy conversion material. Accordingly, aerodynamic performance and various critical design aesthetics which are characteristic of a traditional low hood are preserved. The highly space and weight efficient cushioning effect of the novel material disclosed herein permits optimization of under hood components, hard points and overall packaging for mechanical purposes, weight distribution, cooling, other performance issues, cost, aesthetic design considerations, and other commercial or practical reasons.

Fenders, roof panels, bumpers, bumper beams, impact structures, windshield mounting interfaces, and other components are also optionally produced with the novel material system disclosed herein.

Other benefits of the novel material system disclosed herein include: reduced bonnet or hood weight, adaptability to virtually all under-bonnet or hood hard points, closer packaging of hood and under-hood components, optimized placement and packaging of under-hood components, improved sound damping, improved thermal insulation, and co-molded features for integration of systems such as photovoltaics in hood or roof panels. Significantly reduced tooling investment and tooling production lead time are two secondary benefits of this technology.

The constituent materials of the novel material system disclosed herein can be processed in one of several robust methods depending upon capital investment constraints and throughput requirements. Processing methods include but are not limited to oven cure, low-pressure press cure, resin infusion, resin transfer molding oven heating and vacuum infusion of resin film, or other processes. The material supply chain for the constituent materials is well established in the UK, Europe, the US, and other parts of the world.

According to several embodiments, thermoplastic or thermoset prepreg materials are utilized in this system, but other reinforcement forms are also be used Fiberglass is optionally utilized for production cost considerations. The use of thermoplastic prepreg enables complete recyclability of the pedestrian protection hood or bonnet and other pedestrian protection components. Materials from renewable sources are also useful for constituent materials of the novel material system disclosed herein in lower-temperature areas of the vehicle, or in higher temperature areas of the vehicle when the thermal performance of the renewable material is sufficient.

Class A surface finish is optionally achieved on the novel material disclosed herein through one of several commercialized or novel approaches. Hard points made from metal, composites, or other materials, such as latches, hinge mounts, hood or bonnet undertrays and other features are optionally co-molded or secondarily bonded to the novel pedestrian protection material.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a single-thickness standard energy absorption material;

FIG. 2 illustrates a thicker version of the standard energy absorption material;

FIG. 3 illustrates a single-thickness standard energy absorption material having a locally thicker portion;

FIG. 4 illustrates a single-thickness standard energy absorption material having a locally thicker portion with tapered or staggered edges;

FIG. 5 illustrates a version of the standard energy absorption material having a locally thicker portion with tapered or staggered edges and without prepreg covering the thicker ply portion;

FIG. 6 illustrates a version of the standard energy absorption material having a locally thicker portion with tapered or staggered edges and with prepreg covering the thicker ply portion;

FIG. 7 illustrates a version of the standard energy absorption material having a locally thicker portion with tapered or staggered edges and with prepreg covering the entire side having the thicker ply portion as well as the prepreg covering the thicker ply portion;

FIG. 8 illustrates a version of the standard energy absorption material having a some thicker layers, or varying thickness of layers;

FIG. 9 illustrates another version of the standard energy absorption material having a some thicker layers, or varying thickness of layers;

FIG. 10 illustrates a version of the standard energy absorption material having a locally thicker foam portion;

FIG. 11 illustrates a version of the standard energy absorption material having a locally thicker foam portion and extra layers of material over the thicker foam portion, as well as a layer of insulating material and an extra layer of insulating foam;

FIG. 12 illustrates a version of the standard energy absorption material having a locally thicker foam portion and extra layers of material over the thicker foam portion wherein the extra layers of material have tapered or staggered edges;

FIG. 13 illustrates a version of the standard energy absorption material having locally thicker foam portions between adjacent prepreg plies;

FIG. 14 illustrates a version of the standard energy absorption material having locally thicker foam portions between localized thicker layered portions of the energy absorption material as well as thinner foam portions;

FIG. 15 illustrates another version of the standard energy absorption material having locally thicker foam portions between localized thicker layered portions of the energy absorption material;

FIG. 16 illustrates a metal skin, composite skin, or other surfacing layer over the standard energy absorption material, for example being utilized in an automotive hood of standard or thinner thickness, the metal skin, composite skin, or other surfacing layer being operable in combination with any of the versions of energy absorption materials illustrated in FIGS. 1 through 15;

FIG. 17 illustrates the metal skin, composite skin, or other surfacing layer over the standard energy absorption material, as illustrated by example and without limitation in FIG. 16, and further having localized stiffening and energy absorption provided by layered composite of the energy absorption materials illustrated herein; and

FIG. 18 illustrates a contoured piece of the energy absorption material.

### DETAILED DESCRIPTION

In the Figures, like numerals indicate like elements.

An energy absorption material 7 and associated configurations, processes and application approaches are disclosed for, though not limited to pedestrian impact energy absorption for vehicle hoods and fenders, as well as other applications which are disclosed herein.

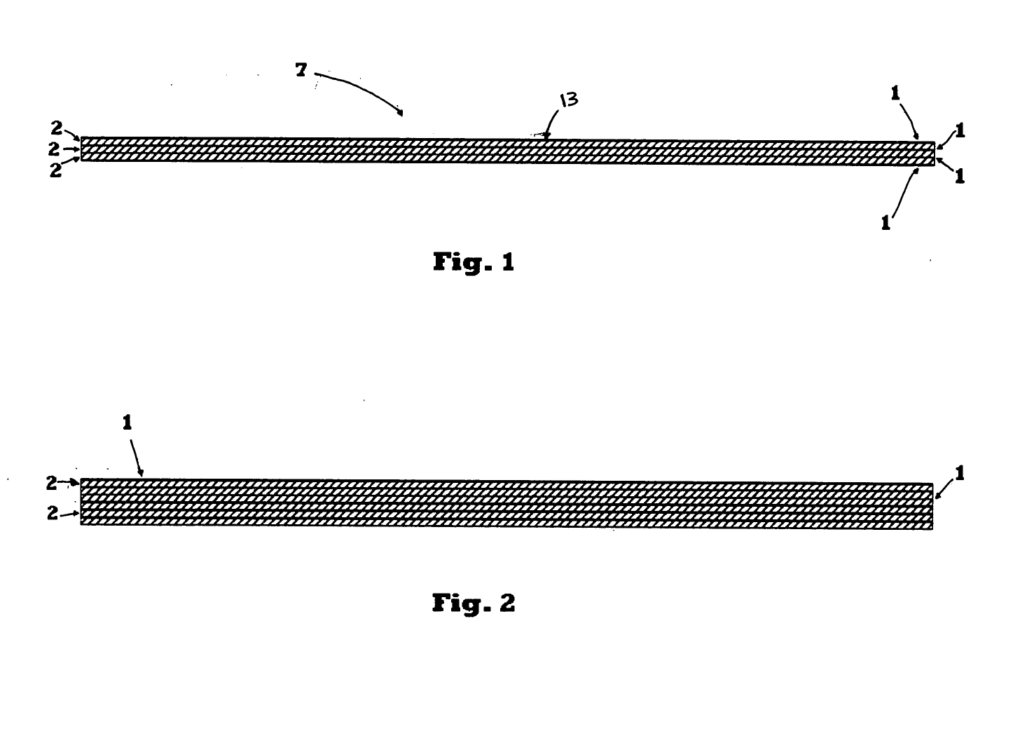

The energy absorption material 7, shown in FIG. 1, is a plurality of thin structural layers of a substantially rigid material 1 with cushioning layers of a compressible material 2 alternating between the thin structural layers of material 1. According to one embodiment, constituent materials include a thermoplastic nylon foam with a thermoset epoxy resin prepregged onto woven fiberglass. For example, the thermoplastic nylon foam for the layers of compressible material 2 is a type of foam Zotek-N B50 available from Zotefoams, of Croydon, Surrey, UK and Walton, Ky., USA, and one example of the thermoset epoxy resin prepreg with fiberglass reinforcement for the thin layers of structural material 1 is a type of prepreg made by Cytec Engineered Materials.

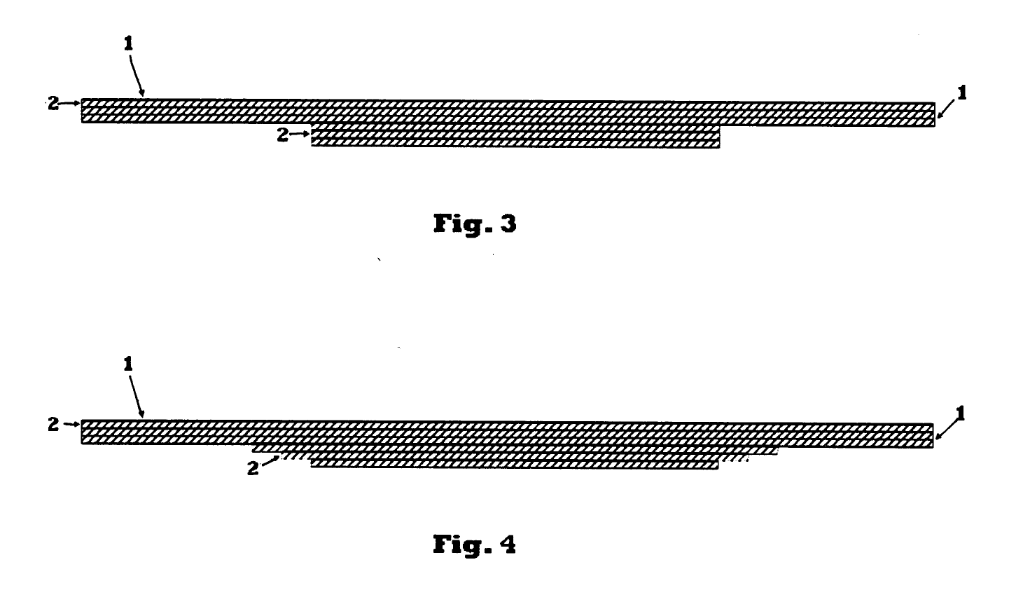

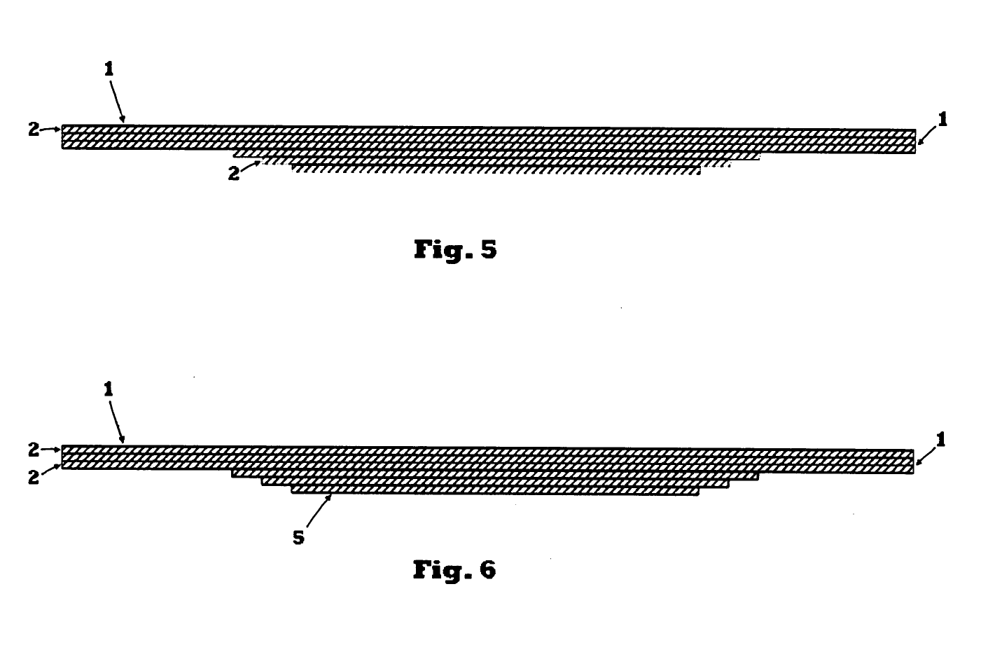

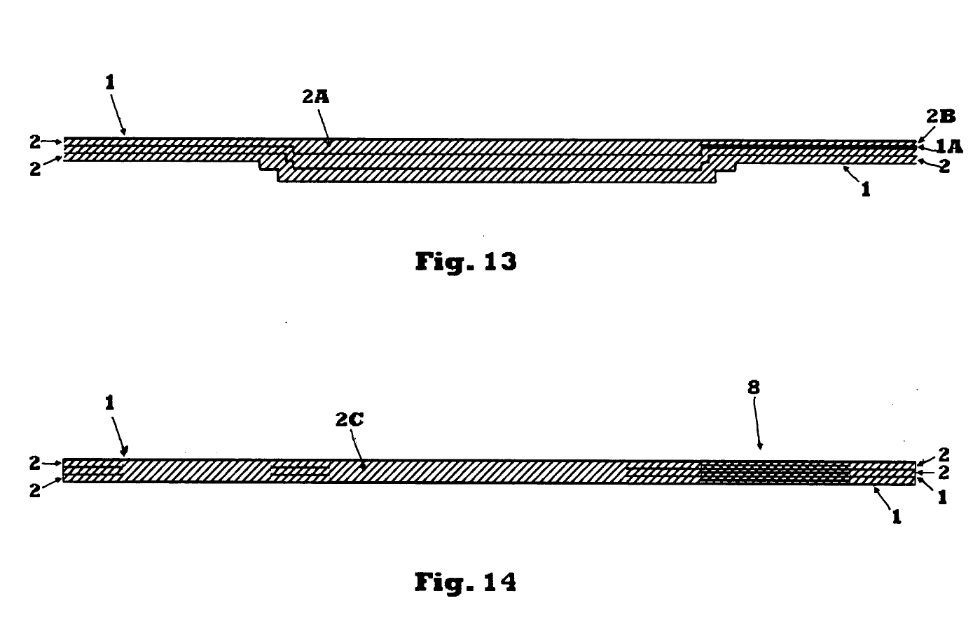

The energy absorption material 7 disclosed herein includes alternating thin structural layers of material 1 and compressible material 2 forming an interleaving, or interleaved material. For example, the prepreg fiberglass composite material forms the thin structural layers of material 1, and cushioning layers of compressible material 2 are a foam material or other compressible material alternating between the thin structural layers of material 1. The interleaved layers of materials 1 and 2 are optionally of different stiffness, density, brittleness, compressive strength, and thickness as shown in FIGS. 8, 9, 10, 11, 12, 13, 14, 15, to achieve different energy absorption characteristics. In addition, the thickness of the resulting energy absorption material 7 is optionally varied in different locations as shown in FIGS. 3, 4, 5, 6, 7, 11, 12, 13, 17 to achieve different levels of energy absorption depending on the underlying structure and desired level of impact absorption performance. For example, thicker areas are optionally utilized over areas having hard points including the engine, the latch, the windshield wipers, and the hinges of a vehicle, which have more impact influence on pedestrian protection.

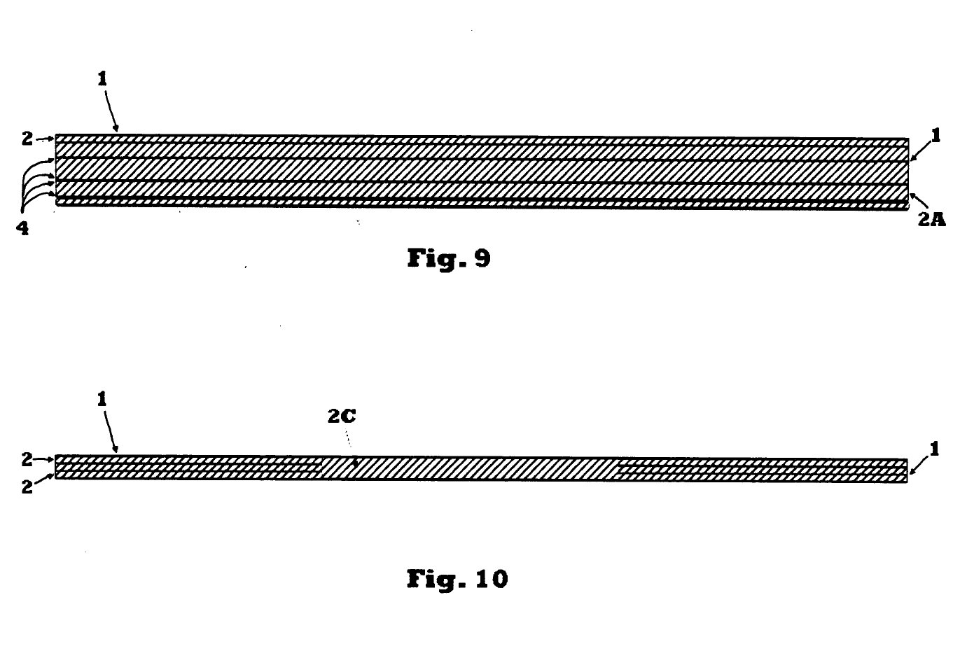

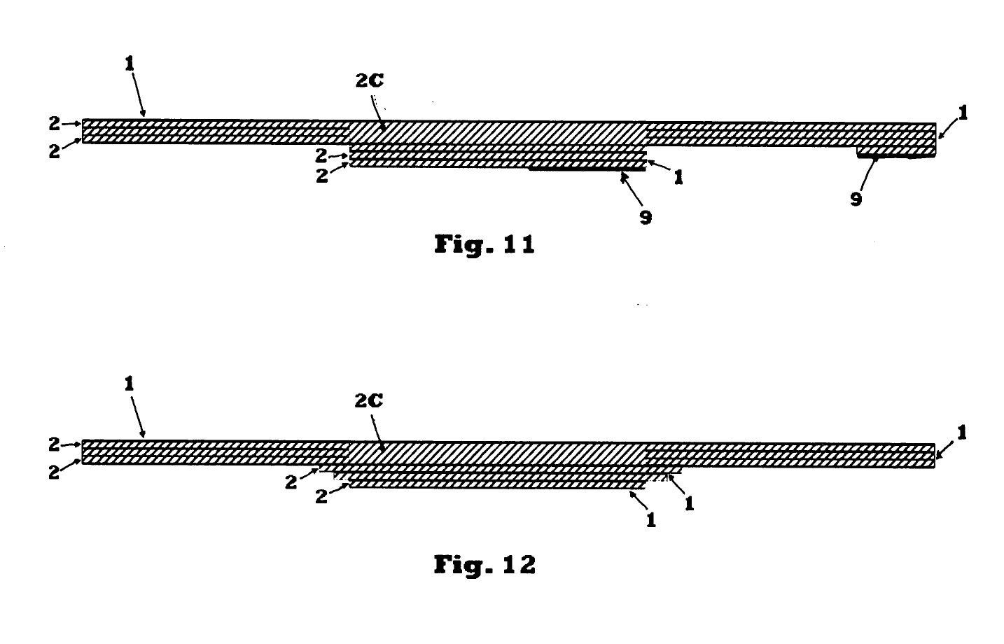

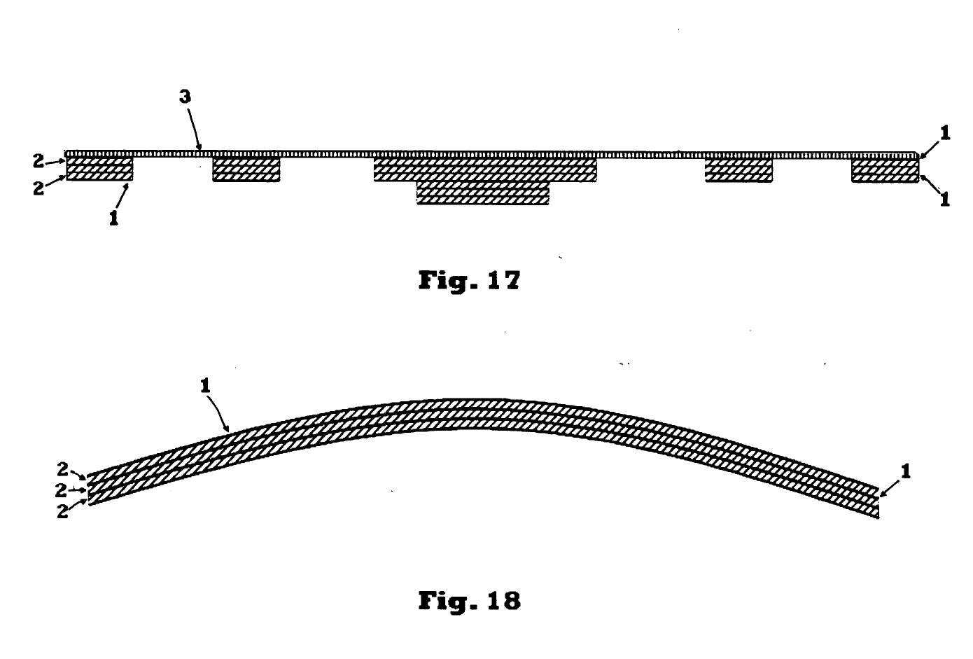

The thickness of the resulting energy absorption material 7 is optionally varied by any of adding more layers of materials 1 and 2; making thicker layers 1A or 2A of materials 1 and 2; making some thinner layers 1B or 2B of materials 1 and 2; providing more layers 8 of materials 1 and 2 on inside, i.e., between top and bottom layers; providing fewer layers 2C of material 2 on inside FIGS. 10, 11, 12, 14, 15; or more layers on one side or both sides with or without an outer layer 3 covering and/or smoothing finish surface, as shown in FIGS. 16 and 17. See, also, FIGS. 3, 4, 5, 6, 7, 11, 12, 17. Insulating material 9 can be added to the material either in the form of another insulating material, as shown in FIG. 11, or an extra layer of compressible material used as insulation material 9 in FIG. 11. Additional ways of varying thickness or configurations as well combinations thereof are also contemplated and can be utilized without departing from the spirit and scope of the invention.

The energy absorption material 7 is, for example, processed in a standard vacuum bagging process, utilizing a press, or utilizing another standard or novel or proprietary process.

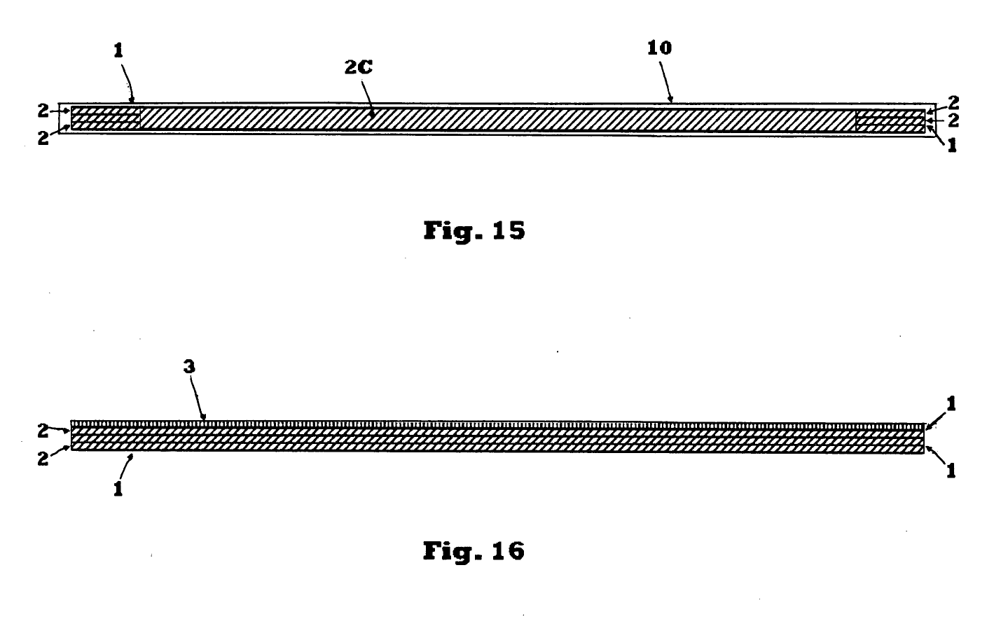

Processing of the laminated or interleaved energy absorption material 7 includes bonding of adjacent layers wherein intimate contact is provided by consolidation pressure. Optionally, heat is used to cure or melt polymer resin systems for adhesion to adjacent layers, e.g., oven heating with vacuum wherein the prepreg bonds by differential atmospheric pressure of a sealed vacuum bag, or a heated press wherein the prepreg bonds by force exerted by the press and heat provided by heated platens or heated molds. Each layer of materials 1 and 2 is adhered to the adjacent layers such that each layer adheres to the other layers. Otherwise, as shown in FIG. 15, interleaved layers of materials 1 and 2 are contained by one or more external layers 10 that retain positioning of internal interleaved layers of materials 1 and 2. Consolidation pressure, e.g., by vacuum, press, autoclave, or another consolidation pressure process, is used to ensure there is intimate contact between adjacent interleaved layers of materials 1 and 2. The energy absorption material 7 disclosed herein is optionally processed in a standard vacuum bagging process, in a press, or in a number of other standard or proprietary processes which consolidate the layers of materials 1 and 2.

A one-sided prepreg, wherein resin is applied to only one side of a reinforcing fiber fabric, is optionally utilized as the thin layers of structural material 1 as an aid in evacuating air to ensure intimate contact between adjacent interleaved layers of materials 1 and 2. Alternatively, a standard fiber and resin prepreg material is utilized as the thin structural layers of material 1. Utilization of such standard fiber and resin prepreg material as the thin structural layers of material 1 nominally raises a higher risk of entrapping small amounts of air because there are not dry fibers along which air can easily travel from the lay-up; however, such risk is mitigated or eliminated by process development. Alternatively, the thin structural layers of material 1 are provided by dry fabric and resin films placed adjacent to each other to achieve the desired effect of evacuating entrapped air. Other alternative processes introduce resin just prior to the molding stage, during assembling of the layers of materials 1 and 2, or subsequent to assembling the layers of materials, in a resin infusion or resin transfer molding process.

The layer of foam or other compressible or collapsible material 2 serves to absorb some of the energy in a cushioning manner, while each structural layer of the composite material 1 buckles and fails individually as the laminated or interleaved energy absorption material 7 compresses. This individual failure of the structural layers of material 1, along with the cushioning nature of the layers of compressible material 2, causes the energy absorption material 7 to achieve a smooth energy absorption curve, resulting in minimal peak loads upon impact.

A delamination mechanism is optionally used to absorb and convert additional impact energy. The delamination mechanism operates between adjacent layers of interleaved materials 1 and 2 by fracturing of the resin at a bond line 4, shown in FIG. 9, wherein the fracture absorbs and converts impact energy. Optional combinations of polymers or polymer foams causes the adjacent layers of prepreg and foam materials 1 and 2 to delaminate the interface therebetween at each bond line 4, thereby allowing energy absorption and conversion due to fracture, as well as displacement of the materials 1 and 2 in the direction of impact due to interlaminar shearing and resulting interlaminar slip.

The energy absorption material 7 disclosed herein is sufficiently stiff in flexure that it maintains its shape in service, while still allowing compression through the thickness of the material which is the direction transverse to, or normal to, the plane of the layers of materials 1 and 2, as would occur in a pedestrian head impact scenario. The energy absorption material 7 is also useful for other applications wherein compression or energy absorption is desirable, as well as in such applications as aircraft interior sidewalls where acoustic insulation, thermal insulation, and lightweight properties are desired. The temperature resistance capability of both the composite material 1 and the foam or other compressible or collapsible material 2 is sufficient for automotive component applications, including but not limited to hood and fender applications. According to several embodiments, epoxy resin systems are utilized as material 1 that have a service temperature range of below freezing to 275 degrees F., with many systems capable of 350 degrees F. service temperature. Other epoxy systems are capable of over 400 F service temperature. Other polymer based resin systems have similar temperature capability. Other materials, such as metals, have much higher temperature performance, often above 700 degrees F. In automotive applications, the material will likely be exposed to heat only on one side, the other side of the component being exposed to ambient conditions. Due to the self-insulating nature of the foam material 2, the energy absorption material 7 disclosed herein can be exposed to higher temperatures on one side of the material without affecting the performance of the rest of the material system. The recommended service temperature of nylon foam is 190 degrees F. Other materials such as polypropylene foam have a slightly lower temperature capability, whereas metal foams can high a service temperature capability above 700 degrees F.

The surface of the energy absorption material 7 is able to achieve high quality class-A finish through a thin surfacing layer 3 as shown in FIG. 16, e.g., hydroformed, super-plastic formed, or pressed metal layer, a metal sprayed layer, a ceramic layer, a ceramic sprayed layer, an infused metal powder layer, a polymer system layer such as the surfacing system of Gurit of Newport, Isle of Wight, UK, which is a resin-rich epoxy surface layer, a composite surface layer, or other known or proprietary processes for achieving high quality surface finishes. Other suitable known proprietary surfacing systems include the surfacing system of Advanced Composites Group (ACG) of Heanor, Derbyshire, UK, and Toray Composites America of Tacoma, Wash., USA, which are unidirectional prepreg materials. Both ACG and Toray have proprietary materials and often related proprietary processing methods for achieving good surface finish, as well. Gurit's system is a resin rich surface layer, which includes resins such as both epoxy and thermoplastic resins. ACG's process is quite similar to Gurit's system, with the exception that ACG's process focuses on reducing resin rich interstitial areas, which tend to shrink over years of heat exposure and cause an uneven surface. Toray's process focuses on a unidirectional/nonwoven fiber-rich surface which does not have small interstitial resin rich areas. As illustrated by these examples, there are many suitable ways for achieving a smooth surface of the energy absorption material. Thick materials such as metal or ceramic are optionally utilized as surfacing layer 3 to provide additional armoring capability.

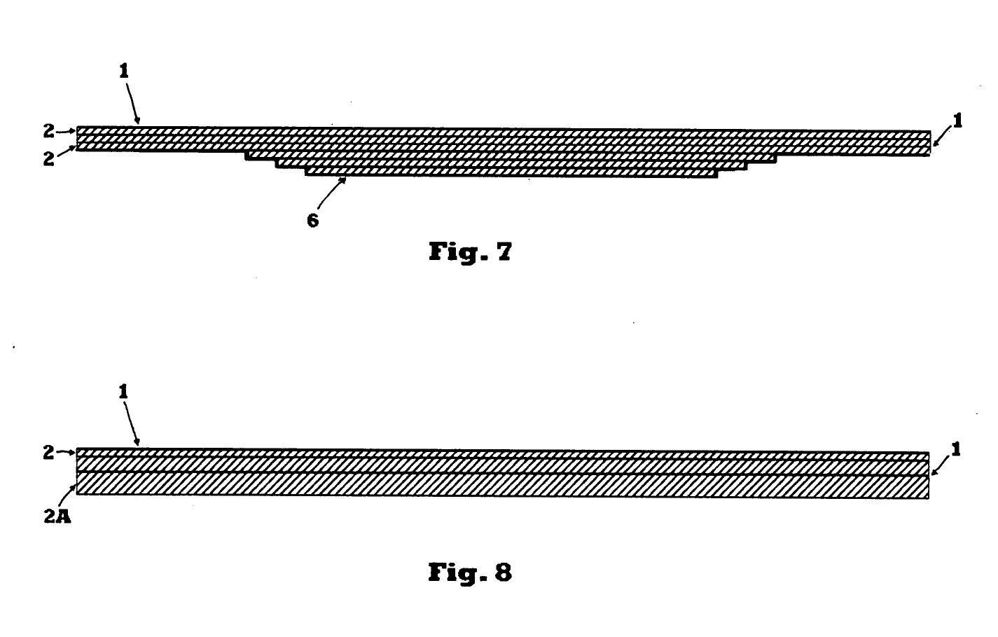

As shown for example in FIG. 6 and FIG. 7, the underside 5 of the energy absorption material 7 or component utilizing the energy absorption material 7, such as an automobile engine compartment hood component, optionally includes localized or substantially coextensive reinforcement material 6. Such reinforcement material 6 includes for example, but is not limited to, solid pieces of metal, composite material, or other material which reinforces some areas of the component. By example and without limitation, reinforcement material 6 reinforces such areas as latch and hinge mount portions of the automobile engine compartment. As shown in FIG. 10, other materials 9 can be attached to the underside of the hood for heat reflection and/or insulation, sound dampening, and/or aesthetics purposes.

The energy absorption material 7, material configurations, and processes provide much needed pedestrian head impact performance, weight savings, aesthetics, e.g., by maintaining lower hood outline, closer packaging of hood and engine components, improved cost relative to other energy absorption solutions, sound damping, reduced tooling cost and lead time relative to traditional metal forming processes and other composites processes, and other commercial and performance parameters, such as aerodynamics, which is a function of hood height, design, and other automotive design factors. One or more embodiments disclosed herein provide complete recyclability of the energy absorption material.

Regarding potential materials utilized in the disclosed interleaved energy absorption material 7, i.e., Zotek-N B50 nylon foam material 2 and fiberglass and epoxy prepreg material 1, there are some general parameters for and characteristics of material system and the resulting components made from such materials. For example, in manufacturing automobile hoods utilizing this energy absorption material 7, a material thickness in the range of about 0.125″ to over about 4 inches is possible, but a range of about 0.5″ to about 2.5″ may be adequate for desirable stiffness, strength, and pedestrian protection capability. This energy absorption material 7 performs effectively at over 190 degrees F., and provides adequate performance at even higher engine bay temperatures when insulating materials 9 are used, such as heat reflectors or additional layers of materials 1 and 2, as shown for example in FIG. 11.

Regarding density, about 1.24 pounds per foot square is the average aerial density of a typical pedestrian protection hood utilizing the interleaved energy absorption material 7 disclosed herein, including paint and fixing with varying material thickness, in the range from about 0.75 inch to 1.125 inch to about 1.875 inch. For example, the density of this energy absorption material 7 would result in a hood of about 17.4 pounds for an RSX model Acura automobile, which is approximately 14 square feet. By comparison, the stock steel hood currently utilized by Acura for the RSX model application weighs more than 30 pounds. For an automobile hood manufactured using this energy absorption material 7 and a thickness of about 0.75 inch, the resulting painted hood with fixings would have an average aerial density of about 0.8 pounds per square foot.

This energy absorption material 7 disclosed herein also provides thermal and acoustical insulation. The materials 1 and 2 utilized in this energy absorption material 7 are optionally materials from renewable sources. Thermoplastic foams utilized in several disclosed embodiments are recyclable, and other recyclable materials 1 and 2 are optionally utilized to produce components that are fully recyclable.

Applications and Resulting Material Functionality:

Blast Mitigation Seat

The interleaved layers of materials land 2, such as prepreg fiberglass and nylon or polypropylene foam, are laminated, pressed by hydraulic press, or otherwise formed into or onto a mold and subsequently heated or cured with consolidation pressure to form energy absorbing blast-mitigation seat structure. The layers of materials 1 and 2 provide sufficient stiffness for seating purposes and when impacted, the energy absorption material 7 serves as an energy absorbing structure immediately next to the body of the occupant of the resultant blast seat.

The blast seat provides protection from ballistic projectiles, spall, high rates of acceleration, and also blast shockwaves. In the case of ballistic projectiles, the high-tensile-strength fibers of material 1 strain in tension and compression as they compress the interleaved layers of foam material 2, failing sequentially, rather than catastrophically, as happens in monolithic laminates. Some monolithic laminates delaminate to provide each layer a certain amount of space to strain the fibers, effectively converting projectile kinetic energy into breakage of fibers, shearing of fibers, fiber pull-out, friction, plastic deformation, delamination fracturing, and other mechanisms of energy conversion. The disclosed interleaved material does not need to delaminate because the structural layers of material 1 are already separated by layers of foam material 2 and effectively strain, break, and shear the fibers or other structural material 1. The substantially coextensive layers of foam material 2 provide a large area which strains and provides displacement to effectively strain the fibers in the adjacent structural layers of material 1. In prior art monolithic rigid laminates that do not delaminate, the projectile energy is focused on one small area of the laminate and the local stresses exceed the shear or compressive strength of the material, whereupon the material fails, potentially resulting in penetration of the laminate.

For high rates of acceleration, such as a mine blast or Improvised Explosive Device (TED) blast, the disclosed energy absorption material 7 compresses, layer-by-layer, effectively spreading the force of acceleration of the occupant's body over a larger area to convert and momentarily store some of the kinetic energy of the blast, thereby limiting the peak acceleration loads in the seat occupant's body and brain. As the layers compress, the fiberglass or other structural layer material 1 buckles, bends, breaks, or strains to convert and store energy. The cushion layers of foam or other compressible material 2 compresses, deforming either permanently or temporarily to store energy and limit peak loads which can damage the seat occupant's body or brain.

For blast energy attenuation, the layers of the two materials 1 and 2 interact symbiotically, attenuating energy due to the different density and modulus of the two materials. The shockwave compresses the material, spreading the energy across the seat, also damping the shockwave so that when the shockwave's energy is imparted to the seat occupant, its energy has been diminished. The materials 1 and 2 also act to momentarily store and also convert some of that energy, partially due to the different sonic velocities of the interleaved layers of materials 1 and 2, limiting peak loads in the seat occupant's body and brain.

Interior Components for Vehicles

Interior components of vehicles may require impact energy management for occupant safety. Such interior components may include deformable dashboards or glove boxes for impact from occupant legs or heads, as well as components such as door trim panels. The disclosed interleaved energy absorption material 7 provides sufficient stiffness for interior component applications, but also cushions impacts. In the case of an impact, the disclosed interleaved energy absorption material 7 compresses and fails sequentially, layer by layer of materials 1 and 2, cushioning occupant impact with these components. Also, this disclosed interleaved energy absorption material 7 provides thermal and acoustical insulation for improved occupant comfort.

Interior Components for Aircraft

Some aircraft interior components require stiffness, impact resistance, thermal insulation and acoustical insulation. For example, aircraft interior sidewall and ceiling panels are typically constructed of fiberglass fabric preimpregnated with phenolic resin skins along with a honeycomb core made from nomex paper saturated with phenolic resin. These prior art materials are lightweight and offer some thermal and acoustical insulation. However, the disclosed interleaved energy absorption material 7 provides improved thermal and acoustical insulation and is optionally processed by current tooling and equipment utilized for aircraft sidewall and ceiling construction. Acoustical insulation is provided by the energy-damping interface of the interleaved layers of the two materials 1 and 2 of different density and modulus. Thermal insulation is primarily provided by the layers of foam material 2 due to its low density and high void content and resulting reduced amount of polymer material.

For aircraft seats, head impact energy management for crash or emergency landings and turbulent flight is a critical issue. Occupant's heads can easily hit the seat in front of them, potentially causing brain injury or death. The cushioning nature of the disclosed energy absorption material 7 when used for forming the seat structure absorbs and stores impact energy and limits peak loads in the brain.

Aircraft ducting is optionally produced with the disclosed interleaved energy absorption material 7 because of the material's self-insulating and structural properties. The disclosed interleaved energy absorption material 7 is formed by a sheet of polymer foam material 2 being laid on top of a sheet of material 1 such as fiberglass fabric preimpregnated with epoxy resin. The materials 1 and 2 are rolled onto a mandrel at least two compete rolls. The rolled materials 1 and 2 are cured to form an interleaved, self-insulating ducting material. The disclosed interleaved energy absorption material 7 attenuates vibration energy in the aircraft, resulting in quieter operation of the ducting system. Thermal energy is conserved through the insulating properties of the layers of foam material 2.

Vehicle Structures and Other Structures for Blast Mitigation and Ballistic Projectile Protection

Vehicle structures are optionally produced with the interleaved energy absorption material 7 disclosed herein. The structures include, for example, one of more of the vehicle floor, chassis, sidewalls, and roof. To produce structural vehicle components, thicker or multiple laminated layers of structural material 1 such as a prepreg fiberglass, Kevlar, or carbon fiber with epoxy or phenolic resin are interleaved with compressible layers of material 2 which are either load bearing or non-load bearing in nature. The resulting interleaved energy absorption material 7 damps blast shockwaves due to the difference in density and modulus of the two materials. The interleaved energy absorption material 7 disclosed herein also allows compression and sequential straining and failure of the structural layers of material 1, storing and converting energy from blast shockwaves and ballistic projectiles, protecting occupants. The structural layers of material 1 are optionally thinner, the same thickness, or thicker than the compressible layers of material 2. If utilizing sufficient interleaved layer thickness and overall material thickness, structural components such as floors, chassis, sidewalls and roofs are producible.

Body Armor

Body armor materials and components are optionally produced with the interleaved energy absorption material 7 disclosed herein. The structural layers are optionally produced from prepreg materials 1 like those made from fiberglass and phenolic resin. Another option for the structural layers of material 1 is unidirectional high-tensile-strength fibers in a thermoplastic or thermoset resin. The options for the layers of compressible material 2 include foams and other materials which both cushion impacts and allow the fibers to strain, layer-by-layer, through compression of the compressible material. The resulting interleaved energy absorption material 7 is optionally placed on either side, or both sides, of a ceramic armor plate. If placed on the back, the interleaved energy absorption material 7 will cushion the impact from projectile, limiting blunt impact trauma and defeating spall. The interleaved energy absorption material 7 also helps hold the ceramic material in place, especially if placed on both sides, or if non-interleaved prepreg material 1 is also placed on a threat or strike face 13 opposite the interleaved material on the back face, improving multiple-hit performance of the ceramic. If a ceramic armor plate is not used, this interleaved energy absorption material 7 is optionally used as a standalone armor system, or as a supplementary system to typical armor vests. In addition, molded body armor shapes are optionally produced to better fit wearers' bodies. Custom-molded body armor is optionally produced to individual wearers' bodies through custom pattern making from materials similar to those used to make torso splints for spine fractures.

While the preferred and additional alternative embodiments of the invention have been illustrated and described, it will be appreciated that various changes can be made therein without departing from the spirit and scope of the invention. Therefore, the inventor makes the following claims.

1. An energy absorption material, comprising:
a plurality of structural layers each comprising a substantially rigid material;
a plurality of cushion layers interleaved with the structural layers, each of the cushion layers comprising a substantially compressible material;
wherein the cushion layers are coupled to adjacent structural layers; and
one of the cushion layers and the structural layers is further positioned on a threat face of the energy absorption material.

2. The material of claim 1, further comprising an adhesion bond line formed between adjacent structural and cushion layers.

3. The material of claim 2, further comprising a delamination mechanism operable between adjacent structural and cushion layers.

4. The material of claim 1, wherein the substantially rigid material of the structural layers further comprises a material selected from a group of materials consisting of: sheet metal material, fiber reinforced composite material, natural fiber and resin composite material, sheet molding compound material, thermoset plastic sheet material, thermoplastic sheet material, carbon nanotube sheet material, and particle-based aggregate or composite material.

5. The material of claim 1, wherein the substantially compressible material of the cushion layers further comprises a material selected from a group of materials consisting of a honeycomb structure of one of a metal material, a polymer material, or a cellulose material; a corrugated material; an aerogel material; a three dimensional knit or weave material with pillar-like reinforcement; an air filled pocket material; polyethylene terephthalate foam material; and a compressible foam material selected from a group of substantially compressible foam materials consisting of a thermoset polymer foam material, a thermoplastic polymer foam material, a polystyrene foam, a syntactic foam material, a microcellular foam material, a nano cellular foam material, a macrocellular foam material, a nylon foam material, a polypropylene foam material, a polyactic acid naturally-derived polymer foam material.

6. The material of claim 1, wherein the substantially rigid material of the structural layers and the substantially compressible material of the cushion layers each further comprises a material having a service temperature of about 190 degrees F. or greater.

7. The material of claim 1, wherein a quantity of one of the structural layers and the cushion layers varies across the threat face of the energy absorption material.

8. The material of claim 1, wherein a thickness of one of the structural layers and the cushion layers varies across the threat face of the energy absorption material.

9. The material of claim 1, further comprising an insulation layer coupled to at least one of the structural and cushion layers, the insulation layer further comprising a layer of insulating material.

10. The material of claim 1, further comprising a reinforcement layer coupled to at least one of the structural and cushion layers, the reinforcement layer further comprising a structural reinforcing material.

11. The material of claim 1, wherein the material of one of the structural layers and the cushion layers further comprises a recyclable material.

12. The material of claim 1, wherein the layer on the threat face of the energy absorption material further comprises a non-planar contour.

13. The material of claim 1, further comprising a surfacing layer positioned on one of the threat face of the energy absorption material and an opposing surface thereof.

14. A method for forming an energy absorption material, comprising:
from a substantially rigid material, forming a plurality of structural layers;
from a substantially compressible material, forming a plurality of cushion layers;
interleaving the cushion layers with the structural layers, including positioning one of the structural layers and the cushion layers on an outer threat face of the energy absorption material; and
coupling adjacent structural and cushion layers;

15. The method of claim 14, wherein coupling adjacent structural and cushion layers further comprises forming an adhesion bond between adjacent structural and cushion layers.

16. The method of claim 14, further comprising selecting the substantially rigid material of the plurality of structural layers from a group of materials consisting of sheet metal material, fiber reinforced composite material, natural fiber and resin composite material, sheet molding compound material, thermoset plastic sheet material, thermoplastic sheet material, carbon nanotube sheet material, and particle-based aggregate or composite material.

17. The method of claim 14, further comprising selecting the substantially compressible material of the plurality of cushion layers from a group of materials consisting of a honeycomb structure of one of a metal material, a polymer material, or a cellulose material; a corrugated material; an aerogel material; a three dimensional knit or weave material with pillar-like reinforcement; an air filled pocket material; polyethylene terephthalate foam material; and a compressible foam material selected from a group of substantially compressible foam materials consisting of: a thermoset polymer foam material, a thermoplastic polymer foam material, a polystyrene foam, a syntactic foam material, a microcellular foam material, a nano cellular foam material, a macrocellular foam material, a nylon foam material, a polypropylene foam material, a polyactic acid naturally-derived polymer foam material.

18. The method of claim 14, further comprising selecting both the substantially rigid material of the plurality of structural layers and the substantially compressible material of the plurality of cushion layers to have a service temperature of about 190 degrees F. or greater.

19. The method of claim 14, further comprising forming a different quantity of one of the plurality of structural layers and the plurality of cushion layers across different areas of the threat face of the energy absorption material.

20. The method of claim 14, wherein forming one of the plurality of structural layers and the plurality of cushion layers further comprises forming a different thickness of one of the layers across different areas of the threat face of the energy absorption material.

21. The method of claim 14, further comprising forming the layer on the outer threat face of the energy absorption material with a non-planar contour.

22. The method of claim 14, further comprising coupling an insulation layer to at least one of the structural and cushion layers.

23. The method of claim 14, further comprising coupling a structural reinforcement layer to at least one of the structural and cushion layers.

24. The method of claim 14, further comprising selecting both the substantially rigid material of the plurality of structural layers and the substantially compressible material of the plurality of cushion layers to be a recyclable material.

25. The material of claim 14, further comprising forming a surfacing layer on an outer layer of the energy absorption material.

26. A method for mitigating effects of an impact, the method utilizing an energy absorption material, and comprising:
providing an energy absorption material, comprising providing a plurality of structural layers with a first of the plurality of structural layers being further positioned for providing a threat face of the energy absorption material, and further comprising providing a plurality of cushion layers interleaved with the structural layers;
positioning the threat face of the energy absorption material for receiving an impact,
receiving an impact on the threat face of an energy absorption material;
converting a first portion of an impact energy of the impact by straining the first structural layer that is positioned for providing the threat face of the energy absorption material;
receiving a remainder of the impact energy on a first of the plurality of cushion layers bonded to an inside face of the first structural layer opposite from the threat face of the energy absorption material;
diffusing a portion of the remainder of the impact energy by compressing the first of the plurality of cushion layers;
successively receiving successively diminished remainders of the impact energy on one or more of a remainder of the plurality of structural layers;
successively converting a portion of each of the diminished remainders of the impact energy by successively straining one or more of the remainder of the plurality of structural layers;
successively receiving a remainder of the portion of each of the diminished remainders of the impact energy on one or more of a remainder of the plurality of cushion layers bonded to an inside faces of each of the remainder of the plurality of structural layers opposite from the threat face of the energy absorption material; and
successively diffusing a portion of each of the diminished remainders of the impact energy by successively compressing one or more of the remainder of the plurality of cushion layers.

27. The method of claim 26, wherein providing an energy absorption material, comprising providing a plurality of structural layers with a first of the plurality of structural layers being further positioned for providing a threat face of the energy absorption material, and further comprising providing a plurality of cushion layers interleaved with the structural layers, further comprises bonding between adjacent structural and cushion layers; and
further comprising converting a portion of the impact energy by delaminating the bonding between one or more adjacent structural and cushion layers.

28. The method of claim 26, wherein converting a portion of an impact energy of the impact by straining the structural layers further comprises displacing the structural layers away from the threat face of the energy absorption material into the cushion layer adjacent thereto.

29. The method of claim 28, wherein diffusing a portion of the impact energy by compressing the cushion layers further comprises momentarily storing a portion of the impact energy in the cushion layers during the compressing of the respective cushion layers.

30. The method of claim 29, wherein converting a portion of an impact energy of the impact by straining the structural layers further comprises at least one of shearing, buckling, bending, heating, and fracturing one or more of plurality of the structural layers.

31. The method of claim 29, further comprising providing each of the converting a portion of an impact energy and each of the diffusing a portion of the impact energy further comprises straining the structural layers and compressing the cushion layers at an operating temperature of at least 190 degrees F.

32. The method of claim 29, further comprising recycling the cushion layers and the structural layers.
